(19) United States
(12) Patent Application Publication
(10) Pub. No.: US 2024/0416551 A1
(43) Pub. Date: Dec. 19, 2024

(54) HYDROPHOBING EMULSION COMPRISING TRIGLYCERIDE WAX

(71) Applicant: WALKER INDUSTRIES HOLDINGS LIMITED, Thorold, Ontario (CA)

(72) Inventors: Niels Mathieu Barbara SMEETS, Courtice, Ontario (CA); Laurence Anthony SINNIGE, Burlington, Ontario (CA); Rebecca Katie HUM, Guelph, Ontario (CA); Hendya DEBESE, Conyers, GA (US)

(21) Appl. No.: 18/694,521

(22) PCT Filed: Sep. 21, 2022
(86) PCT No.: PCT/CA2022/051400

§ 371 Date: Mar. 22, 2024

Related U.S. Application Data
(60) Provisional application No. 63/261,479, filed on Sep. 22, 2021.

(51) Int. Cl. B27N 3/00; B27N 3/08; C11C 1/02

(52) U.S. Cl. CPC B27N 3/002; B27N 3/08; C11C 1/025

(57) ABSTRACT

Hydrophobing emulsion for use in the manufacture of composite wood panels and methods of formulating same. The hydrophobing emulsion comprising triglyceride wax in alkaline aqueous phase, having a free fatty acid content of at least 0.3 w/w % relative to total amount of triglyceride wax, wherein the triglyceride wax has a high drop melt point (DMP) and a low iodine value (IV), and wherein the emulsion is formed at a temperature above the DMP of the triglyceride wax and maintained at a temperature above the DMP of the triglyceride wax until use.

### FIELD

The present invention relates to an aqueous hydrophobing emulsion for use in the manufacture of composite wood panels and methods of formulating the emulsion. More specifically, the invention relates to an aqueous hydrophobing emulsion comprising a self-emulsifying triglyceride wax applied at a temperature above the drop melt point of the triglyceride wax.

### BACKGROUND

The manufacture of wood based panels such as particleboard, fibreboard (such as medium density fibreboard (MDF) and high density fibreboard (HDF)), flakeboard, chipboard, oriented strand board (OSB), waferboard and other similar products (collectively referred to herein as “composite wood panels”) generally comprises a first step of combining wood chips or particles and an adhesive. The mixture is formed into a mat, which is then heated under pressure to cure the adhesive and to form the desired panel. Formaldehyde based resins, such as urea-formaldehyde (UF), are typical adhesives used in the manufacture of such panels. Other types of resins not containing UF may also be used.

In order to improve hydrophobing characteristics of composite wood panels, it is known in the art to include a wax component into the panel manufacturing process. Thus, once the panel is made, the hydrophobic wax serves to repel water from being absorbed, thereby enhancing the dimensional stability of the panel. The effectiveness of wax for production of lignocellulosic articles has been described in the literature; for example Roffael E. et. al. “Zur Hydrophobierung von mitteldichten Faserplatten (MDF) mit Paraffin Teil 1” Holz als Roh-und Werkstoff 2005, 63, 192-203 or Mujika Garai, R. et. al. “Study of the Effect of Raw Material Composition of Water-Repellent Capacity of Paraffin Wax Emulsions on Wood” J. Dispers. Sci. Technol. 2005, 26, 9-18. Additionally, the presence of wax improves the ease of manufacturing of composite wood panels.

Waxes used in composite panel production are typically extracted from the high-boiling fractions during the crude oil refining process. These waxes are referred to as paraffin waxes and, depending on the oil content and wax hardness, can be further classified as slack wax, scale wax, or refined wax. Although direct application of molten wax is used commercially in the manufacture of composite wood panels, paraffin waxes are more commonly applied as dispersions of solid wax particles suspended in water. It is believed that, when compared to molten application, aqueous wax dispersions benefit from improved distribution during application and consequently improved hydrophobing performance. Aqueous wax dispersions are typically prepared through emulsification of molten wax (i.e. heated above the drop melt point of the wax) with an aqueous phase containing appropriate emulsifier(s) and subsequent cooling to ambient temperature. Emulsifiers are used to improve the stability of the dispersion but are known to impede the hydrophobing performance of the wax in the finished product. The use of such emulsifiers thus constitutes a trade-off between aqueous wax dispersion stability (or shelf-life) and hydrophobing performance. In some cases the emulsifier is a combination of a saturated fatty acid and a water-soluble base as is, for example, described in U.S. Pat. No. 2,349,326 by Wilson.

As sustainability requirements are becoming increasingly stringent, suitable alternatives to petroleum-based paraffin wax for use in hydrophobing of composite wood panels are needed. U.S. Pat. No. 8,071,209 B2 by The berge describes blends of paraffin wax and triglyceride wax derived from plant or animal sources as a more sustainable alternative to paraffin wax alone for this purpose. In particular, The berge discloses the use of vegetable or animal oils and fats blended with petroleum slack wax. Although chemically different from paraffin waxes, triglyceride waxes can be formulated to match performance of paraffin wax, such as hydrogenated vegetable oil as is disclosed in U.S. Pat. No. 7,217,301 B2 by Murphy.

Triglyceride wax dispersions can be prepared in a similar fashion as described above for paraffin wax. Triglyceride wax dispersions have been disclosed in the prior art. For example, U.S. Pat. No. 8,076,006 B2 by Wantling discloses an aqueous wax composition comprising a paraffin and triglyceride in the presence of an emulsifier consisting of a fatty acid and base. Triglyceride wax dispersions, and in particular those of low iodine value, suffer from two distinct disadvantages that have limited their usefulness for hydrophobing in composite wood panels. First, triglycerides are prone to saponification and thus are unstable when emulsified in water, resulting in the formation of increasing levels of free fatty acids which are converted to soap in the presence of a base. The increased level of soap can, in turn, reduce the hydrophobing effect of the dispersion. U.S. Pat. No. 2,380,413 by Buxton teaches that the saturated fatty acids (i.e. low iodine value) are more prone to saponification than the unsaturated fatty acids (i.e. high iodine value). Second, triglyceride waxes can crystallize when dispersed in water and cause partial coalescence of the dispersion resulting in high viscosity or complete solidification, as taught by Fredrick E. et al. “Factors governing partial coalescence in oil-in-water emulsions” Adv. Colloid. Inter. Sci. 2010, 153, 30-42. This is especially true for triglycerides of lower iodine value (IV) and higher drop melting point (DMP). Although this feature is desirable for other applications such as providing texture in many food products, it is highly undesirable for aqueous wax dispersions for hydrophobing applications as it impacts aqueous triglyceride wax dispersion stability and shelf-life. This becomes particularly important for the use of triglyceride wax for improving hydrophobing performance of composite panels, as dispersions of triglyceride waxes of relatively high melt point, and low iodine value, are preferred. As a result, the prior art concerning aqueous wax dispersions for hydrophobing is restricted to paraffin-triglyceride blends and/or the use of high IV triglycerides that do not undergo partial coalescence.

There is thus a need for hydrophobing compositions that eliminate the use of non-renewable hydrocarbons, such as paraffin wax, while still providing effective hydrophobing characteristics to the finished product. It is also important that such compositions have properties that are conducive to their application in the manufacture of composite wood panels.

### SUMMARY

Hydrophobing compositions comprising emulsions of triglycerides have been developed to provide hydrophobing characteristics to composite wood panels without the use of paraffin wax or other non-renewable hydrocarbon wax products. It has been further found that these compositions can be prepared without the use of added emulsifiers, thereby providing cost effective and efficient hydrophobing compositions for incorporation in the manufacture of composite wood panels.

Accordingly, in one aspect of the description there is provided an emulsion comprising:
triglyceride wax in alkaline aqueous phase, having a free fatty acid content of at least 0.3 w/w % relative to total amount of triglyceride wax,
wherein the triglyceride wax has a high drop melt point (DMP) and a low iodine value (IV), and
wherein the emulsion is formed at a temperature above the DMP of the triglyceride wax and maintained at a temperature above the DMP of the triglyceride wax until use.

According to another aspect of the description there is provided a method of preparing an emulsion comprising:
a) combining a molten triglyceride wax with an aqueous alkaline phase at a temperature above the drop melt point (DMP) of the triglyceride;
b) emulsifying the mixture while maintaining the temperature above the (DMP) of the triglyceride; and
c) maintaining the emulsion at a temperature above the triglyceride DMP temperature until use;
wherein the triglyceride wax has a high drop melt point (DMP) and low iodine value (IV) and the free fatty acid (FFA) content of the triglyceride is at least 0.3 w/w % relative to the total amount of triglyceride wax.

In a particular aspect the drop melt point (DMP) of the triglyceride wax is in the range of about 30° C. to about 80° C. and in a further aspect the DMP may be in the range of about 45° C. to about 65° C.

In another aspect the iodine value (IV) of the triglyceride wax is below about 35. In a further aspect the IV of the triglyceride may be below about 30 and in yet a further aspect it may be below about 20.

According to a further aspect of the description there is provided a use of an emulsion as described herein in the manufacture of composite wood panels.

According to another aspect of the description there is provided a method of preparing a wood composite panel comprising: combining wood furnish with resin; adding an emulsion as described above or an emulsion made by the method described above; and hot pressing the mixture to form the wood composite panel.

### DETAILED DESCRIPTION

In accordance with the description, there is provided an aqueous hydrophobing emulsion, a method for preparing the aqueous hydrophobing emulsion and its use in the manufacture of composite wood panels.

As used herein, the following terms will be understood to have the following meanings.

“Composite wood panel”, or “panel”, as used herein, will be understood to mean any form of wood or cellulosic material-based panel. “Composite wood panel” will be understood to include particleboard, fibreboard, such as medium density fibreboard (MDF) and high density fibreboard (HDF), flakeboard, chipboard, oriented strand board (OSB), waferboard and other similar products, wherein wood or cellulosic material is mixed with adhesive and formed into a flat panel.

The terms “wood particles”, “wood substrate” or “wood furnish” will be understood to mean wood or lignocellulosic material commonly used in manufacturing composite wood panels. This term will, therefore, be understood to include wood particles, wood chips, wood shavings, wood wafers, wood strands, sawdust or other similar materials.

The term “resin” as used herein refers to an adhesive combined with the wood particles in forming a composite wood panel. Various resin are known in the art for this purpose, such as formaldehyde based resins including urea-formaldehyde (UF) resin. Other types of resins not containing UF are also known in the art and may also be used.

“Dispersion”, as used with respect to the present description, will be understood to mean a composition comprising a liquid continuous aqueous phase and solid dispersed phase, see “IUPAC. Compendium of Chemical Terminology”, 2nd ed. (the “Gold Book”) compiled by A. D. McNaught and A. Wilkinson. Blackwell Scientific Publications, Oxford (1997).

“Emulsion”, as used with respect to the present description, will be understood to mean a composition comprising two immiscible liquids containing a continuous aqueous phase and liquid dispersed phase; see “IUPAC. Compendium of Chemical Terminology”, 2nd ed. (the “Gold Book”) compiled by A. D. McNaught and A. Wilkinson. Blackwell Scientific Publications, Oxford (1997). As known in the art, the term “emulsion” may be used in the reverse, namely, to identify a liquid aqueous phase dispersed within a continuous non-aqueous phase. However, for the purposes of the present description, the invention will generally be described in terms of the former meaning.

“Paraffin wax” as used herein will be understood, as described in Chapter 1 of “Industrial Waxes” by H. Bennett (Chapter 1: Paraffin wax” Industrial Waxes, ed. Bennett H. Chemical Publishing Company Inc., 1975, pp. 3), to mean a purified mixture of solid hydrocarbons obtained from petroleum, a colorless or white, more of less translucent mass, showing crystalline structure, without odor or taste, and slightly greasy to the touch. The petroleum wax may comprise a paraffin wax in the form of a scale wax or slack wax, as obtained from petroleum distillation processes. These waxes are known to be suitable for use in manufacturing composite wood panels.

“Triglyceride” as used herein will be understood to mean a lipid namely a triacylglycerol, or an ester derived of glycerol and one or more fatty acids. Triglycerides can be solid or liquid depending on the composition and molecular structure of the fatty acids. Triglycerides include many natural oil and fat products and are obtained from plant-based or animal-based sources. Depending on the source of the triglycerides and the method of extraction, triglycerides may also include the presence of a small fraction of free fatty acid (FFA).

“Iodine value” or “IV” as used herein will be understood to mean a measure of the chemical unsaturation of a triglyceride. It is measured by iodometry and is expressed as the number of grams of iodine absorbed by 100 grams of triglyceride (mg I₂/100 g).

“Acid value” or “AV” as used herein will be understood to mean a measure of the content of free fatty acid of a triglyceride. It is measured by titration with KOH and is expressed as the number of milligrams of KOH required to neutralize the free fatty acids in 1 gram of triglyceride (mg KOH/g).

“Saponification value” or “SV” as used herein will be understood to mean a measure of the average molecular weight of the fatty acids present in the triglyceride. It is measured by titration with hydrochloric acid after complete saponification of the triglyceride with an excess of KOH. The SV is expressed as the number of milligrams of KOH required to saponify 1 gram of triglyceride (mg KOH/g).

“Free fatty acid content” or “FFA” as used herein will be understood to mean a measure of the content of free fatty acid of a triglyceride. It is calculated based on the acid value assuming that the fatty acids in the triglyceride are of equal molecular weight. Herein, all FFA reported contents are calculated based on oleic acid, where 1 unit of acid value corresponds to 0.503 percent free fatty acid content.

“Drop melt point” or “DMP” as used herein will be understood to mean a measure of the melting point of a paraffin or triglyceride wax. It is determined in accordance with ASTM D127.

“Saponification” as used herein will be understood to mean a chemical reaction between a triglyceride and alkali in the presence of heat, resulting in a free fatty acid salt, or soap.

“Triglyceride wax” as used herein will be understood to mean a triglyceride that has a melting point comparable to that found in paraffin waxes (roughly 110-150° F.). In chemical terms, the melting point of the triglyceride wax correlates to the composition and iodine value of the fatty acids that make up the triglyceride.

“Emulsifier” as used herein will be understood to be a surface-active agent (also called a “surfactant”) which lowers the surface tension of the medium in which it is dissolved, and/or lowers the interfacial tension with other phases. The emulsifier facilitates the formation of an emulsion and increases the colloidal stability of the resulting emulsion of dispersion (IUPAC, Compendium of Chemical Terminology, 2nd ed. (the “Gold Book”) Compiled by A. D. McNaught and A. Wilkinson. Blackwell Scientific Publications, Oxford (1997)).

“Base equivalence” or “BE” as used herein will be understood to mean the molar ratio of base and the AV of the triglyceride wax. A BE=1, indicates molar equivalence between the base and AV of the triglyceride wax.

“Solids” or “solids content” as used herein will be understood to refer to the amount (expressed as a weight percentage) of non-volatile material in the dispersion. More accurately, these terms refer to the total amount of non-volatile material that remains after evaporation or drying to a constant weight.

“Hydrophobing” as used herein will be understood to mean the property of being water repelling.

As used herein, the term “stable aqueous triglyceride wax emulsion” is defined as an aqueous triglyceride wax emulsion displaying no de-emulsification for a period of at least 15 minutes at a temperature above the DMP of the triglyceride, for example at a temperature in the range of 80° C. to 90° C. and under mild agitation. In another embodiment a stable aqueous triglyceride wax emulsion may display no de-emulsification for a period of at least 30 minutes.

As used herein, the term “stable aqueous triglyceride wax dispersion” is defined as an aqueous triglyceride wax dispersion displaying no wax fall-out or change in viscosity for a period of at least 7 days at room temperature. Furthermore, the shear stability of a stable aqueous triglyceride wax dispersion has to be sufficient to withstand common industrial unit operations such as liquid transfer by pumps and liquid application by spray nozzles. For commonly used aqueous paraffin wax dispersions, a shear stability of at least 120 seconds has been empirically determined as sufficient to withstand pumping and spraying. Consequently, a stable aqueous wax dispersion thus requires a shear stability of at least 120 seconds. In practise, it has been found that these stability requirements can only be met by high IV triglyceride wax dispersions and some paraffin-triglyceride blends in the presence of an emulsifier. Aqueous dispersions of low IV triglyceride waxes can be made, however, generally quickly build viscosity and/or solidify.

Hydrophobing emulsions comprising triglyceride wax have been developed for use in the manufacture of composite wood panels. It has been found that aqueous triglyceride wax emulsions according to the description can be used as an alternative to aqueous wax dispersions previously known in the art. The aqueous triglyceride wax emulsions according to the description can be applied to a wood substrate during the manufacture of the wood composite panels.

As described herein, compositions of the description include triglycerides. Trigylcerides (also referred to as triacylglycerides) are esters derived from glycerol and three fatty acids. Triglycerides occur naturally as the fats of animals as well as in some vegetable matter. In nature, triglycerides are synthesized by enzyme systems, which determine that a centre of asymmetry is created about middle carbon of the glycerol backbone, so they exist in enantiomeric forms, with different fatty acids in each position (sn-1, sn-2 or sn-3), Ribeiro, A. P. et al. “Crystallization modifiers in lipid systems” J. Food Sci. Technol. 2015, 52, 3925-3946. The individual fatty acid chains may vary in carbon length and/or in degree of unsaturation, giving rise to a complex mixture of triglycerides contained within a single oil or fat.

Oils and fats can be defined by their measurable chemical properties. In particular,
1) Saponification value or SV which is a measure of the average carbon chain length of all the fatty acids present,
2) Iodine value or IV which is a measure of the average degree of unsaturation of all the fatty acids present,
3) Acid value or AV which can be used to measure the free fatty acid (FFA) content, and
4) Drop melt point or DMP.

The values of SV, IV, and DMP are governed by the composition of the fatty acids that make up the distribution of triglycerides. Most vegetable oils are high in unsaturated fatty acids of 16 and 18 carbons, including linolenic, linoleic, and oleic acids. As a result, many vegetable oils have high IV, low DMP and are liquids at 20° C. Most animal fats are high in saturated fatty acids of 16 and 18 carbons, including stearic, palmitic, and myristic acids. As a result, many animal fats such as tallow and lard have lower IV, higher DMP and are solids at 20° C.

Vegetable oils and some animal fats are unsuited for the purpose of hydrophobing wood composite panels as their high IVs and low DMPs result in higher wax mobility during board pressing. This results in loss of hydrophobic triglycerides from the wood composite, e.g. during steam venting, resulting in poor hydrophobing performance of the final panel. Furthermore, this higher volatility may result in further process issues during manufacturing.

Vegetable oils and animal fats can be partially or fully hydrogenated to decrease the IV and increase the DMP, thereby lowering their mobility during hot pressing. Hydrogenated triglycerides compare more closely in their properties to paraffin wax. The unsaturated triglyceride is hydrogenated in the presence of hydrogen and a metal catalyst. Control over the hydrogenation process affords production of solid triglycerides (at 20° C.) with predetermined IV and DMP. For example, soybean oil consists predominantly of mono and polyunsaturated fatty acids and has a melting point below 0° C. Once, partially or fully hydrogenated into soybean wax, the melting point is elevated and can range from 40-80° C. Industrial examples include hydrogenated tallow products as produced by South Chicago Packing, and hydrogenated vegetable oils as produced by Cargill and ADM.

Albeit desirable for end-use performance in composite wood panels, hydrogenation of triglycerides has physical implications beyond DMP and volatility. Hydrogenation lowers IV by increasing saturated fatty acid content, thereby reducing the natural distribution of fatty acids present within the triglyceride. For example, for soybean oil the natural average fatty acid composition consists of approximately 10% palmitic acid (C16:0), 4% stearic acid (C18:0), 18% oleic acid (C18:1), 55% linoleic acid (C18:2), and 13% linolenic acid (C18:3), Clemente T. E. et al. “Soybean Oil: Genetic Approaches for Modification of Functionality and Total Content” Plant Physiol. 2009, 151, 1030-1040. Upon complete hydrogenation, the composition would theoretically consist of approximately 10% palmitic acid (C16:0) and 90% stearic acid (C18:0). The increase in saturated fatty acid content and decrease in fatty acid composition has two important implications: (1) crystallization of the triglyceride, and (2) saponification of the triglyceride.

Solid triglycerides are characterized by their complex crystallization behavior, Ribeiro, A. P. et al. “Crystallization modifiers in lipid systems” J. Food Sci. Technol. 2015, 52, 3925-3946. Hydrogenated triglycerides are waxy solids at atmospheric conditions and are consequently able to crystalize into a solid polymorph upon cooling from the liquid state. The rate at which triglycerides crystalize is dependent on the atmospheric temperature (i.e. a temperature below the melting point of triglyceride) and the chemical composition of the triglyceride. The reduced fatty acid variability within a hydrogenated triglyceride decreases the crystallization induction period (or nucleation period relative to the beginning of crystal formation), and results in the faster formation of stable p polymorphs. Partially or fully hydrogenated triglycerides are thus expected to crystalize faster.

U.S. Pat. No. 2,380,413 by Buxton teaches that animal and vegetable oils and fats may be selectively and partially saponified, whereby the more saturated fatty acid components are more readily saponified than the less saturated components. In other words, the extent to which the ester-linkage between the glycerol and fatty acid is labile is a function of the IV of the fatty acid. Partially or fully hydrogenated triglycerides are then more susceptible to saponification in the presence of alkali and/or water.

The compositions of this invention comprise emulsions of aqueous triglyceride wax for use in hydrophobing composite wood panels. In one aspect, embodiments of the present emulsions can be distinguished over previously disclosed compositions, in that the emulsion is maintained at a temperature above the DMP of the triglyceride until use. Consequently,
(1) no additional emulsifier is required to stabilize the emulsion, and
(2) triglycerides of low IV can be readily used.

As a result, the composition of the present invention can be made without the use of paraffin or other non-renewable wax sources and also benefit from the performance advantages of avoiding the use of additional emulsifiers.

Suitable triglyceride waxes may have a high DMP in the range of 30° C. to 80° C. In another embodiment the DMP may be in the range of 45° C. to 65° C. Suitable triglycerides also have a low IV, typically below 35. In a further embodiment the IV is below 30. In still a further embodiment the IV is below 20. Nonlimiting examples of suitable triglycerides include hydrogenated castor oil, hydrogenated corn oil, hydrogenated soybean oil, hydrogenated sunflower oil, hydrogenated palm oil, tallow and hydrogenated tallow. Additionally, suitable triglyceride waxes may be blended with other triglycerides provided the DMP of the blend remains in the range of 30° C. to 80° C. and the IV below 35.

The triglyceride wax is applied as an emulsion to the lignocellulosic substrate immediately or shortly after emulsification. Consequently, there is a low need for stability (or shelf life) and the amount of emulsifier used can be significantly reduced or eliminated.

The FFA content of a triglyceride wax is expressed as the weight percentage of free fatty acid as compared to the total amount of triglyceride wax. The FFA content is an estimate calculated based on the measured AV of the triglyceride wax using the molecular weight of oleic acid to represent the mixture of free fatty acids present in the triglyceride.

In one embodiment the FFA content is at least about 0.3 w/w % or at least about 0.35 w/w % or at least about 0.4 w/w % or at least about 0.45 w/w % or at least about 0.5 w/w % or at least about 0.55 w/w % or at least about 0.6 w/w % or at least about 0.65 w/w % or at least about 0.7 w/w %.

In a further aspect the upper limit for FFA content is about 4 w/w % or about 3.5 w/w % or about 3 w/w % or about 2.5 w/w % or about 2 w/w %.

Commercial preparations of triglyceride waxes having low IV and high DMP are typically produced with very low or no FFA content. As these preparations of triglyceride are often used in the food industry, the presence of FFA is avoided and FFA may even be removed, as the presence of FFA can impart an undesirable rancid odor or taste. However, triglycerides can be obtained having a sufficient FFA content (as defined above) that is naturally present. The term “naturally present” as used herein includes FFA that arises naturally in the triglyceride source material (such as tallow or vegetable oil) and/or FFA that arises from processing the source material to obtain the triglyceride having low IV and high DMP. Alternatively, a small amount of FFA can be liberated through controlled saponification of the triglyceride wax. In a third option FFA can be added to the triglyceride to achieve the minimum required FFA content. In any event, no other emulsifier is required to stabilize the aqueous triglyceride wax emulsion. The low amount of emulsifier present improves hydrophobing capability of the composition.

By contrast, the FFA content required to make a stable aqueous triglyceride wax dispersion using a high IV triglyceride wax is approximately 2.0 w/w %, or the addition of an emulsifier is required. Dispersions made with a low IV triglyceride wax at 2.0 w/w/% were found to become viscous and/or solidified.

Prior to forming the emulsion of triglyceride wax and aqueous alkaline phase, the FFA content of the triglyceride wax may be determined and if necessary, adjusted to an appropriate level. In the case where there is insufficient FFA present in the triglyceride wax, the amount of FFA can be increased by saponification. Controlled saponification of the triglyceride wax to achieve a target FFA content can be achieved by blending the triglyceride wax with a base dissolved in a suitable solvent. Suitable bases include metal hydroxides such as potassium and sodium hydroxide, and organic bases such as monoethanolamine. Suitable solvents include methanol, ethanol, glycerol, ethylene carbonate and ethylene glycol. In a particular embodiment saponification can be carried out using potassium hydroxide in ethylene glycol.

The aqueous alkaline phase of the emulsion comprises water and base. In one embodiment the aqueous alkaline phase includes water and a strong base. In a particular embodiment the strong base has a pKa of 9 or greater. In another embodiment the base may be monoethanolamine, potassium hydroxide or triethanolamine. In a particular embodiment the base is monoethanolamine. The presence of the base deprotonates the carboxylic acid to form its conjugate base. The corresponding salt that is formed from the base and the free fatty acids is called a soap and provides stability to the triglyceride wax emulsion.

In a further aspect, the amount of base required is dependent on the AV of the triglyceride wax and should be an amount sufficient to deprotonate at least about 0.3 w/w % of the FFA content of the triglyceride wax. In another embodiment the amount of base is an amount sufficient to deprotonate at least about 0.6 w/w/% of the FFA content of the triglyceride wax.

The base equivalence (BE) of the emulsion comprises the molar ratio of base and available fatty acids where the available fatty acid is determined by the AV of the triglyceride wax. For example, for a triglyceride wax with FFA content of 0.3 w/w % a BE=1.2 would be sufficient to deprotonate the free fatty acid present and would produce a stable emulsion, whereas for a triglyceride wax with FFA content of 1 w/w % a BE=0.33 would be sufficient to deprotonate 0.3 w/w % of the available FFA relative to the total triglyceride and would also produce a stable emulsion.

In one aspect, a mixture of triglyceride wax and aqueous alkaline phase are emulsified at a temperature above the drop melt point. The emulsion is formed by applying an amount of shear sufficient to emulsify the liquid triglyceride wax and aqueous alkaline phase. As known in the art, different high shear mixing devices may be used to emulsify a triglyceride wax with the aqueous alkaline phase to form a stable aqueous triglyceride wax emulsion. The efficiency of the high shear mixing device is dependent on the energy provided to create sufficient inertial forces to overcome the surface tension forces. Commonly used high shear devices include rotor-stator mixers and high-pressure homogenizers, and more recently, SmartWax™ branded technology developed by Smartech to provide full on-site wax emulsification systems to OSB panel manufacturers. In both devices, a coarse emulsion of two immiscible liquids passes through a narrow gap, which causes high inertial forces that result in one of the liquid phases to break up in small droplets. Another type of emulsification device is based on ultrasonic cavitation, where high intensity ultrasound generates cavitation bubbles that, upon implosion, cause intensive shockwaves and high local velocities which can emulsify one liquid in another. These high shear mixing devices are commonly used to produce aqueous wax dispersions.

Yet another shear mixing device is based on hydrodynamic cavitation (a so-called liquid whistle), where a coarse emulsion of two immiscible liquids at high pressure passes through a narrow orifice and over a blade, causing formation of cavitation bubbles that, upon implosion, cause intensive shockwaves and high local velocities which can emulsify one liquid in another. An example of such as device is the Sonolator™ as produced by Sonic Corporation.

The aqueous triglyceride wax emulsions according to the description can be produced using different high shear mixing devices, including the Silverson™ mixer (rotor-stator type), APV 31MR Lab Homogenizer (homogenizer type), and the Sonolator™ (hydrodynamic cavitation type). In one example the aqueous triglyceride wax mixture is homogenized using a a high speed mixer (such as Silverson™) first at a pressure in the range of 200 to 3500 psi (first stage) and then at pressure in the range of 0-500 psi (second stage). In another embodiment mixing can be done with an impeller blade at 300 rpm or more before passing through a homogenizer.

In one embodiment the aqueous triglyceride wax emulsions is produced on-site and immediately or shortly thereafter applied onto the lignocellulosic substrate. In another embodiment the aqueous triglyceride wax emulsion is stored for a period of time at a temperature above the drop melt point until use.

The present application also relates to a method of preparing a hydrophobing emulsion. In one embodiment there is provided a method for preparing a hydrophobing emulsion as described above. In one embodiment, the emulsion is prepared by combining molten triglyceride with alkaline aqueous phase at a temperature above the drop melting point (DMP) of the triglyceride. The molten triglyceride having a free fatty acid (FFA) content of at least 0.3 w/w % relative to the total amount of triglyceride wax and also having a low iodine value (IV), and a high DMP. The combined aqueous alkaline phase and triglyceride wax is emulsified while maintaining the mixture at a temperature above the DMP. The emulsion is maintained at a temperature above the DMP until use.

In a further aspect, the method includes a step of providing a triglyceride having a low IV, high DMP and a FFA content of at least 0.3 w/w %, prior to the step of combining the triglyceride with the aqueous alkaline phase. In one embodiment, the triglyceride starting material having a low IV, and high DMP already has a sufficient amount of FFA. In another embodiment, the method may include a further step of carrying out controlled saponification of the triglyceride in order to achieve a sufficient level of FFA. In still a further embodiment, the method may include the step of adding FFA to the triglyceride in order to reach a sufficient level of FFA. The method may further include a step of determining the free fatty acid content of a triglyceride in order to determine if the FFA level is sufficient and if additional FFA is required, to determine the amount of FFA to be added either directly or by saponification to achieve a sufficient level of FFA.

In a further aspect of the method includes a step of providing an alkaline aqueous phase having sufficient base to deprotonate at least 0.3 w/w % FFA. In another embodiment the amount of base in the alkaline aqueous phase is sufficient to deprotonate at least 0.6 w/w % FFA.

### Examples

### Methods

Free fatty acid content (FFA) was determined according to ASTM D5555 with some modifications. A standardized potassium hydroxide solution (0.1 N) was used in lieu of sodium hydroxide as a titrant. For FFA between 0.2-1% a quantity of 15.0±0.2 g was used. Isopropanol (99%) was chosen over ethanol (95%) to completely solubilize the triglyceride. The FFA content is calculated based on oleic acid.

Shear stability was determined by shearing approximately 500 g of triglyceride wax dispersion (conditioned to 25° C.) in a Silverson L4R high shear mixer equipped with a general purpose disintegrating head at 6000 rpm. The shear stability is measured as the time in seconds required to irreversibly destabilize the triglyceride wax dispersion.

### Triglyceride Wax Dispersion Stability

Triglyceride wax dispersions of varying iodine value and drop melt point were produced using the following procedure. First, the FFA content of the triglyceride wax was determined using the method described above. If required, stearic acid was dissolved into a melted triglyceride wax to achieve the desired FFA content. Second, the molten wax mixture (80-100° C.) was then emulsified using an aqueous phase (80-90° C.) containing monoethanolamine (1.0 w/w % in the aqueous phase) under high shear to form a coarse emulsion at 50 w/w % solids. The coarse emulsion is then passed through a high-shear homogenizer at 2500/500 psi to form a fine emulsion and cooled to a temperature below the congealing point of the wax. The triglyceride wax dispersion viscosity and stability was monitored for a period of up to two weeks.

TABLE 1

| | | | DMP | | | |
|---|---|---|---|---|---|---|
| | | IV | point | | | |
| | | [g/100 | [° F./ | FFA | Viscosity | Storage |
| Source | Product | g] | ° C.] | [w/w %] | [cP] | [days] |
| Tallow | Fryer's | 47-55 | 113 / 45 | 0.62 | 15.5 | >14 |
| | Choice | | | | | |
| Tallow | SCP125 | 35 | 125 / 52 | 0.60 | 17 | >14 |
| | | | | 0.80 | 20 | >14 |
| | | | | 1.00 | 21 | >14 |
| Tallow | SCP135 | 20 | 135 / 57 | 0.49 | 18 | <1 |
| | | | | 0.55 | 16 | <1 |
| Tallow | SCP140 | 0.5 | 143 / 62 | 0.60 | 15 | <1 |
| | | | | 0.80 | 16 | <1 |
| | | | | 1.00 | 19 | <1 |
| Soy | S113 | 60-64 | 113 / 45 | 0.61 | 15 | >14 |
| Soy | S130 | 30-40 | 130 / 54 | 0.78 | 20 | <4 |
| Soy | S155 | <5 | 155 / 68 | 0.61 | 32 | <1 |
| Sunflower | — | <5 | 154 / 68 | 1.20 | 47 | <7 |

IV = iodine value, DMP = drop melt point, FFA = free fatty acid content. All aqueous triglyceride wax dispersions prepared at 50 w/w % solids content.

The results in Table 1 demonstrate that the preferred low IV triglyceride waxes, with drop melting points in the useful range, cannot be used to prepare stable aqueous triglyceride wax dispersions. These triglyceride wax dispersions typically show an increase in viscosity after preparation and gel or solidify within days. High IV triglyceride wax dispersions can be used to prepare aqueous wax dispersions. However, they have insufficient shear stability to be considered useful.

### Triglyceride Wax Emulsion Stability

Triglyceride waxes of varying iodine value and melting point were emulsified using the following procedure. First, the FFA content of the triglyceride wax was determined using the method described above. If required, stearic acid was dissolved into a melted triglyceride wax to achieve the desired FFA content. Second, the molten wax mixture (80-100° C.) was then emulsified using an aqueous phase (80-90° C.) containing monoethanolamine (1.0 w/w % in the aqueous phase) under high shear form a coarse emulsion at 50 w/w % solids. The coarse emulsion is then passed through a high-shear homogenizer at 2500/500 psi to form a fine emulsion and kept at a temperature above the congealing point of the wax to maintain the wax emulsion (80-90° C.) under slight agitation. A stable triglyceride wax emulsion is defined as displaying no de-emulsification for a period of at least 15 minutes. In a further embodiment the triglyceride wax emulsion displays no de-emulsification for a period of at least 30 minutes. Contrary to the triglyceride wax dispersions reported in Table 1, aqueous triglyceride wax emulsions of similar composition were all found to be stable.

These results demonstrate that limitations related to the use of certain triglyceride waxes can be overcome by applying the composition as an aqueous triglyceride wax emulsion rather than as a dispersion.

### Determination of Minimum FFA and Base Required for Self-Emulsification

Stearic acid was dissolved into a melted triglyceride wax to achieve a theoretical FFA content. The actual FFA content was measured using the method described above. The molten wax mixture (80-100° C.) was then emulsified using an aqueous phase (80-90° C.) containing monoethanolamine under high shear to form a coarse emulsion at 50 w/w % solids. The coarse emulsion is then passed through a high-shear homogenizer at 2500/500 psi to form a fine emulsion. One part of the fine emulsion is cooled quickly to a temperature below the congealing point of the triglyceride wax to form a triglyceride wax dispersion. The remaining part of the fine emulsion is kept at a temperature above the congealing point of the wax to maintain a triglyceride wax emulsion under slight agitation.

In the absence of base, the coarse emulsion quickly de-emulsifies and no fine emulsion can be produced.

In the presence of base the following results were observed:

TABLE 2

| | | Measured | | | Shear | | |
|---|---|---|---|---|---|---|---|
| Triglyceride | | FFA | BE | Stable | Stability | Storage | Stable |
| wax | Source | [w/w %] | [—] | Emulsion | [s] | [days] | Dispersion |
| Tallow | Fryer's Choice | 0.02 | 230 | N | n/a | n/a | N |
| | (IV = 47-55; | 0.29 | 15.8 | Y | n/a | n/a | N |
| | DMP = 40-45° C. ) | 0.56 | 8.2 | Y | n/a | n/a | N |
| | | 0.62 | 7.4 | Y | 20 | n/a | N |
| | | 0.67 | 6.9 | Y | 21 | >7 | N |
| | | 1.00 | 4.6 | Y | 36 | >7 | N |
| | | 2.00 | 2.3 | Y | 95 | >7 | N |
| | | 3.00 | 1.5 | Y | >430 | >7 | Y |
| Tallow | SCP140 | 0.33 | 13.9 | Y | n/a | n/a | N |
| | (IV < 0.5; | 0.42 | 10.9 | Y | n/a | n/a | N |
| | M.P. = 143° F.) | 0.48 | 9.6 | Y | 13 | 5 | N |
| | | 0.64 | 7.2 | Y | 43 | 5 | N |
| | | 2.00 | 2.3 | Y | 123 | <1 | N |
| Soy | S113 | 0.33 | 13.9 | Y | 5 | >7 | N |
| | (IV = 60-64; | 0.61 | 7.5 | Y | 14 | >7 | N |
| | M.P = 113° F.) | | | | | | |
| Soy | S155 | 0.03 | 153 | N | n/a | n/a | N |
| | (IV < 5; | 0.33 | 13.9 | Y | 12 | <1 | N |
| | M.P. = 155° F.) | 0.61 | 7.5 | Y | 26 | <1 | N |

Table 2 demonstrates that if the FFA content is below a minimum FFA content value, no stable triglyceride wax emulsion or dispersion can be made. It further demonstrates that a stable triglyceride wax dispersion can only be produced in the presence of a substantially larger amount of FFA content.

TABLE 3

| | | Measured | | |
|---|---|---|---|---|
| Triglyceride | | FFA | BE | Stable |
| wax | Source | [w/w %] | [—] | Emulsion |
| Tallow | SCP110 (IV = | 0.10 | 1.20 | N |
| | 48.5-50.5; | 0.20 | 1.20 | N |
| | DMP = 41-43° C.) | 0.30 | 1.20 | Y |
| | | 0.40 | 1.20 | Y |
| Soy | S155 (IV < 5; | 0.10 | 1.20 | N |
| | M.P. = 155° F.) | 0.20 | 1.20 | N |
| | | 0.30 | 1.20 | Y |
| | | 0.40 | 1.20 | Y |

Table 3 demonstrates that a stable triglyceride wax emulsion can be produced in the presence of a minimum FFA content of approximately 0.3 w/w % or higher and in presence of an amount of base that is at least sufficient to deprotonate a FFA content of approximately 0.3 w/w % or higher.

TABLE 4

| | | Measured | | |
|---|---|---|---|---|
| Triglyceride | | FFA | BE | Stable |
| wax | Source | [w/w %] | [—] | Emulsion |
| Tallow | SCP110 (IV = | 0.30 | 0.80 | N |
| | 48.5-50.5; | | 1.00 | N |
| | DMP = 41-43° C.) | | 1.20 | Y |
| Soy | S155 (IV < 5; | 0.30 | 0.80 | N |
| | M.P. = 155° F.) | | 1.00 | N |
| | | | 1.20 | Y |
| | | 0.60 | 0.60 | Y |
| | | 1.20 | 0.30 | Y |
| | | 2.40 | 0.15 | Y |

Table 4 demonstrates that a stable triglyceride wax emulsion can be produced in the presence of a minimum amount of base relative to the FFA content of the triglyceride wax. The minimal amount of base should be sufficient to deprotonate at least approximately 0.3 w/w % of FFA content. It further demonstrates that lower BE may be used when the FFA content of the triglyceride wax exceeds the minimum FFA content of 0.3 w/w %, provided sufficient base is added to deprotonate 0.3 w/w % or more of the FFA content.

In order to demonstrate and compare emulsions of triglyceride having varying amounts of FFA, the above examples, have been prepared by adding FFA from an external source to achieve a prescribed level of FFA content. It is also contemplated that triglyceride already having the required FFA content may be used directly to form the emulsion or that the required FFA content may be obtained by controlled saponification of the triglyceride. In such cases no external FFA would be added.

### COMPARATIVE EXAMPLES

### U.S. Pat. No. 7,776,928 B2 Example 1

Example 1 from U.S. Pat. No. 7,776,928 B2 by Borsinger et al. was made using Naturewax S155 (Cargill) and IGEPAL CO-630 (Solvay). The procedure and amounts of additives were followed directly as reported in U.S. Pat. No. 7,776,928 B2 to obtain a 35% solids aqueous Naturewax S155 dispersion. The prior art reports that this procedure yielded a “stable, milk colored emulsion”. Although the term “emulsion” is used in U.S. Pat. No. 7,776,928 B2 to describe the product, this use of the term does not align with the definition of “emulsion” used herein. Step 9 of example 1 in U.S. Pat. No. 7,776,928 B2 states “cool material to 30-35 degrees C. by use of a heat exchanger or cooling vessel”, and therefore the product of this procedure is a dispersion rather than an emulsion according to the definitions used herein. However, a stable aqueous Naturewax S155 dispersion could not be produced by following the method of Example 1, as solidification occurred when cooled to approximately 35° C.

### U.S. Pat. No. 7,776,928 B2 Example 2

Example 2 from U.S. Pat. No. 7,776,928 B2 by Borsinger et al. was made using Naturewax S155 (Cargill) and Toximul TA-5 (Stepan). The procedure and amounts of additives were followed directly as reported in U.S. Pat. No. 7,776,928 B2 to obtain a 35% solids aqueous Naturewax S155 dispersion. Similar, to example 1, the prior art reports that this procedure yielded a “stable, milk colored emulsion”. As described above the composition produced is a dispersion rather than an emulsion according to the definitions used herein. However, a stable aqueous Naturewax S155 dispersion could not be produced by following the method of Example 2, as solidification occurred when cooled to approximately 60° C.

The results of these experiments show that, contrary to the assertions made in U.S. Pat. No. 7,776,928 B2, stable low IV triglyceride wax dispersions cannot be made.

### U.S. Pat. No. 8,343,634 B2 Example 1

Two aqueous wax dispersions were produced according to the formulation as reported as example #1 in Table 1 of U.S. Pat. No. 8,343,624 B2. Fryer's Choice Tallow (Hubberts Industries) was used as a high IV beef tallow (IV=47-55). SCP140 (South Chicago Packaging) was used as a low IV beef tallow (IV<0.5). The procedure and amounts of additives were taken directly as reported in U.S. Pat. No. 8,343,634 B2 to obtain a 45% solids aqueous tallow dispersion. In our hands, a stable aqueous triglyceride wax dispersion was produced using the high IV beef tallow, whereas the low IV beef tallow wax dispersion quickly thickened and coagulated.

The results of this experiment shows that, in alignment with the assertions made in U.S. Pat. No. 8,343,642 B2, triglycerides with an IV of less than 35 when used alone cannot be used to make stable aqueous triglyceride wax dispersions.

### Self-Emulsification Through Saponification

An aliquote of potassium hydroxide dissolved in a suitable solvent is added to 400 g of a molten triglyceride wax (80-100° C.) with a FFA content of 0.03 w/w % and an IV=47, and mixed at a low speed (˜300 rpm) for 15 minutes. The resulting molten wax is subsequently emulsified using an aqueous phase (80-90° C.) under high shear to form a coarse emulsion at 50 w/w % solids. The coarse emulsion is then passed through a high-shear homogenizer to form a fine emulsion. One part of the fine emulsion is cooled quickly to a temperature below the congealing point of the triglyceride wax to form an aqueous wax dispersion. The remaining part of the fine emulsion is kept at a temperature above the congealing point of the wax to maintain an aqueous wax emulsion (80-90° C.) under slight agitation.

In the absence of potassium hydroxide, the coarse emulsion quickly de-emulsifies and no fine emulsion can be produced using the high-shear homogenizer.

In the presence of 0.1 w/w % potassium hydroxide, for example through the addition of 15 mL of 0.5 N potassium hydroxide in methanol a stable triglyceride wax emulsion can be produced. The amount of potassium hydroxide added corresponds to 0.6 w/w % FFA at complete saponification.

In the presence of 0.1 w/w % potassium hydroxide, for example through the addition of 15 mL of 0.5 N potassium hydroxide in methanol a triglyceride wax dispersion can be produced. The amount of potassium hydroxide added corresponds to 0.6 w/w % FFA at complete saponification. The resulting triglyceride wax dispersion has a solids content of 49.1%, a pH of 10.2, and a viscosity of 14.2 cP. However, this triglyceride wax dispersion does not meet the criteria of a stable triglyceride wax dispersion as the shear stability is insufficient.

The results of this experiment demonstrate that a self-emulsifiable triglyceride wax composition can be produced and readily emulsified into a stable triglyceride wax emulsion.

### Continuous Emulsification

A stable low IV triglyceride wax emulsion was prepared using a Sonolator™, a high pressure ultrasonic homogenizer produced by Sonic Corporation. First, a triglyceride phase was prepared by dissolving stearic acid into a fully hydrogenated soy wax. The target FFA content is 0.65 w/w %. This triglyceride phase was subsequently emulsified with water in the presence of a monoethanolamine base, to create a hot triglyceride wax emulsion at 50% solids. The triglyceride, water, and base mass flowrates constituted 49.00/0.50/50.50 w/w % of the total flow rate of 10.25 lbs/min. A 0.001 in² orifice was used at a target pressure of 2100 psi.

The hot triglyceride emulsion produced was collected in a heated tank and kept at under mild agitation at a temperature above the melting point of the wax. Over a period of 30 min, the hot triglyceride wax emulsion displayed no de-emulsification.

A sample of the hot triglyceride emulsion was quickly cooled to a temperature below the DMP of the triglyceride wax. This triglyceride wax dispersion quickly increased in viscosity, thickening to a point beyond use as a hydrophobing wax dispersion composition.

The above experiment was subsequently repeated by without dissolving stearic acid into the fully hydrogenated soy wax. The measured FFA content of the wax 0.03 w/w %. This triglyceride phase was subsequently emulsified with water in the presence of a monoethanolamine base, to create a hot triglyceride wax emulsion at 50% solids. The triglyceride, water, and base mass flowrates constituted 49.00/0.50/50.50 w/w % of the total flow rate of 10.25 lbs/min. A 0.001 in² orifice was used at a target pressure of 2100 psi.

The hot triglyceride emulsion produced was collected in a heated tank and kept at under mild agitation at a temperature above the melting point of the wax. The hot triglyceride wax emulsion was unstable and quickly de-emulsified and inverted.

The results of this experiment demonstrate that stable hot triglyceride wax emulsions can be produced for low IV triglyceride waxes in the presence of a sufficient FFA content.

Although the invention has been described with reference to certain specific embodiments, various modifications thereof will be apparent to those skilled in the art without departing from the purpose and scope of the invention as outlined in the claims appended hereto. Any examples provided herein are included solely for the purpose of illustrating the invention and are not intended to limit the invention in any way. Any drawings provided herein are solely for the purpose of illustrating various aspects of the invention and are not intended to limit the invention in any way. The disclosures of all prior art recited herein are incorporated herein by reference in their entirety.

1. An emulsion comprising:
a triglyceride wax in alkaline aqueous phase, having a free fatty acid (FFA) content of at least 0.3 w/w % relative to total amount of triglyceride wax,
wherein the triglyceride wax has a high drop melt point (DMP) and a low iodine value (IV), and
wherein the emulsion is formed at a temperature above the DMP of the triglyceride wax and maintained at a temperature above the DMP of the triglyceride wax until use.

2. The emulsion of claim 1, wherein the triglyceride wax has an IV below 35, or the triglyceride wax has an IV below 30, or the triglyceride wax has an IV below 20.

3. (canceled)

4. (canceled)

5. The emulsion of claim 1, wherein the triglyceride wax has drop melt point (DMP) of 30° C. to 80° C.

6. (canceled)

7. (canceled)

8. The emulsion of claim 1 wherein the FFA content is at least 0.6 w/w % relative to total amount of triglyceride wax.

9. The emulsion of claim 1, wherein the FFA content is equal to or less than 4 w/w % relative to total amount of triglyceride wax.

10. (canceled)

11. The emulsion of claim 1, wherein the alkaline aqueous phase comprises water and a base wherein the base is a strong base having a pKa equal to or greater than 9 or the base is triethanolamine.

12. (canceled)

13. (canceled)

14. (canceled)

15. The emulsion of claim 1 wherein the amount of base is at least sufficient to deprotonate an amount of FFA, where the amount of FFA is at least 0.3 w/w % relative to the total amount of triglyceride wax.

16. (canceled)

17. The emulsion of claim 1 wherein the amount of base is up to about 1.0 w/w % in the aqueous phase.

18. The emulsion of claim 1, wherein the required FFA content is naturally present in the triglyceride wax or the required FFA content is achieved by controlled saponification of the triglyceride wax by addition of base in a suitable solvent or the required FFA content is achieved by addition of FFA to the triglyceride wax.

19. (canceled)

20. (canceled)

21. (canceled)

22. (canceled)

23. (canceled)

24. (canceled)

25. (canceled)

26. (canceled)

27. (canceled)

28. A method of preparing an emulsion comprising:
a) combining a molten triglyceride wax with an aqueous alkaline phase at a temperature above the drop melting point (DMP) of the triglyceride;
b) emulsifying the mixture while maintaining the temperature above the (DMP) of the triglyceride; and
c) maintaining the emulsion at a temperature above the triglyceride DMP temperature until use;
wherein the triglyceride wax has a high drop melt point (DMP) and low iodine value (IV) and the free fatty acid (FFA) content of the triglyceride is at least 0.3 w/w % relative to the total amount of triglyceride wax.

29. The method of claim 28 wherein the DMP of the triglyceride wax is from 30° C. to 80° C.

30. (canceled)

31. The method of claim 28 wherein the IV of the triglyceride wax is below 35, or the IV of the triglyceride wax is below 30, or the IV of the triglyceride wax is below 20.

32. (canceled)

33. (canceled)

34. The method of claim 28 wherein the step of emulsifying the mixture is achieved by high shear mixing.

35. (canceled)

36. The method of claim 28 wherein the FFA content of the triglyceride wax is at least 0.3 w/w % relative to the total amount of triglyceride wax.

37. (canceled)

38. The method of claim 28 wherein the alkaline aqueous phase comprises water and a base wherein the base is a strong base having a pKa equal to or greater than 9 or the base is triethanolamine.

39. (canceled)

40. (canceled)

41. (canceled)

42. The method of claim 38 wherein the amount of base is at least sufficient to deprotonate an amount of FFA, where the amount of FFA is at least 0.3 w/w % relative to the total amount of triglyceride wax.

43. (canceled)

44. The method of claim 38 wherein the amount of base is up to about 1.0 w/w % in the aqueous phase.

45. The method of claim 28 further comprising the step of providing the triglyceride wax wherein the step of providing the triglyceride further includes a step of determining the FFA content of the triglyceride and a step of adding FFA, if required, to reach an FFA content of at least 0.3 w/w % relative to total amount of triglyceride wax and wherein the step of adding FFA to reach FFA content of at least 0.3 w/w % relative to total amount of triglyceride wax comprises adding FFA directly or increasing the FFA content by controlled saponification of the triglyceride wax.

46. (canceled)

47. (canceled)

48. The method of claim 45 wherein the triglyceride wax provided has an FFA content of at least 0.3 w/w % relative to total amount of triglyceride wax, naturally present.

49. (canceled)

50. (canceled)

51. (canceled)

52. (canceled)

53. A method of preparing a wood composite panel comprising;
combining wood furnish with resin;
adding an emulsion according to claim 1;
hot pressing the mixture to form wood composite panels.

54. (canceled)

55. (canceled)
